(19) United States
(12) Patent Application Publication
(10) Pub. No.: US 2017/0331212 A1
(43) Pub. Date: Nov. 16, 2017

(54) Method for producing an electrical connection part

(71) Applicant: Auto-Kabel Management GmbH, Hausen i.W. (DE)

(72) Inventors: Jens DÖREN, Jülich (DE); Thomas LORENZ, Kaarst (DE)

(21) Appl. No.: 15/531,039

(22) PCT Filed: Sep. 17, 2015
(86) PCT No.: PCT/EP2015/071276

§ 371 Date: May 26, 2017

(30) Foreign Application Priority Data
Dec. 4, 2014 (DE) 10 2014 017 886.2

(51) Int. Cl. H01R 13/03; C25D 5/48; C25D 7/00; H01R 43/16

(52) U.S. Cl. CPC H01R 13/03; H01R 43/16; C25D 5/48; C25D 7/00

(57) ABSTRACT

The subject matter of the invention relates to a method for producing an electrical connection part, in which an electrical conductor (2) is provided, the electrical conductor (2) is electroplated and a contact area (4)of the conductor (2) is exposed by removing the electroplating (6). A method is to be specified with the subject matter of the invention which enables an electroplating (6) provided on the connection part (22) to be removed in a way which is particularly cost-effective and reliable. This is achieved according to the subject matter of the invention by removing the electroplating (6) in the contact area (4) using a beaming source (8).

The subject matter relates to a method for producing an electrical connection part, in which an electrical conductor is provided, the electrical conductor is electroplated and a contact area of the conductor is exposed by removing the electroplating. The subject matter of the invention also relates to an electrical connection part produced according to this method.

In order to protect electrical connection parts, in particular for motor vehicles, against environmental influences, it is known to plate an electrically conducting core of the connection part. The document DE 10 2008 035 863 A1 describes, for example, a motor vehicle connection part, whose conductor core consisting of an aluminium part and a copper part is peripherally electroplated. The plating in particular covers a joint formed between the aluminium part and the copper part and in this way protects against corrosion of the electrically conducting junction between the copper and the aluminium. In this way, an electrically conducting connection between the aluminium part and the copper part can be permanently guaranteed. The core of the connection elements formed from the aluminium part and the copper part is, according to the production method known from DE 10 2008 035 863 A1, masked with an adhesive tape at a distance from the joint before electroplating takes place, so that the plating can be subsequently removed locally in the masked area by pulling off the adhesive tape. In this way, the aluminium part or the copper part can be exposed for connecting a conductor, while, at the same time, the joint remains protected by the plating.

The above described masking of the conductor core to be plated is, however, laborious, since the surface the adhesive tape is to be stuck to has to be very smooth and free of contaminants and lubricant, in order to guarantee a reliable adhesion of the adhesive tape. In addition, automated production of such a connection part with an above described masking step in a way which makes sense for operational practice is only possible using a cost-intensive strip electroplating process, in which providing and applying the adhesive tape generate costs.

Against the background of the above described prior art, the subject of the invention was based on the object of specifying a method for producing an electrical connection part which does not have, or at least only to a lesser degree has, the above mentioned disadvantages and which enables an electroplating provided on the connection part to be removed in a way which is particularly cost-effective and reliable. An electrical connection part produced using this method should also be specified.

With regard to the method, this object was achieved by a method according to the subject matter of the invention, in which the method steps specified in claim 1 are passed through. In addition, the object was achieved by an electrical connection part according to claim 12.

In a first method step, an electrical conductor is firstly provided. The electrical conductor in particular forms an electrically conducting core of the connection element and can, for example, be a flat conductor which can have a conductor cross-section which in particular is essentially rectangular. In further embodiments, at least partly rounded, in particular oval or circular, conductor cross-sections can be provided.

The electrical conductor provided is electroplated in a subsequent method step. The conductor can be coated with one or more layers. In particular, layers consisting of nickel and/or tin or similar metals, or alloys which contain nickel and/or tin or similar metals, can be electrochemically deposited on the electrical conductor. The electrical conductor is protected against chemical and mechanical environmental influences, in particular against corrosion, by the plating.

It was identified that the removal of an electroplating provided on the connection part can be made possible in a cost-effective and reliable way by removing the electroplating in the contact area using a beaming source. Laborious masking of the electrical conductor, which is at least partly to be stripped of its plating to expose the contact area, can thereby be dispensed with. The layer to be electro-deposited is therefore applied to the whole surface of the electrical conductor facing the environment, wherein the conductor is directly and completely covered by the layer without any intermediate elements. In this way, a homogenous layer application with an essentially constant layer thickness can be guaranteed. In particular, the plating can be removed in the contact area essentially free of residue by means of the beaming process. The beaming process can be equally used for layer stripping and for cleaning and smoothening the surface of the contact area. In particular, compared to the masking described in the introduction, there is the advantage that after layer stripping no contaminants resulting from the process, such as adhesive residues or tape residues, stick to the surface in the contact area.

The plating is preferably locally removed on the connection part by means of the beaming source so that no tool, such as a milling or grinding tool, mechanically acts upon the connection part. Hence, a layer can be gently removed by the beaming source, wherein the properties of the border zone in the contact area of the electrical conductor, like the material structure or the residual stresses—and hence its electrical properties too—are not negatively affected by excessive input of heat or high treatment forces.

In addition, by means of the beaming treatment, the geometry of the contact area to be exposed can be essentially freely chosen, since the surface exposed by the jet/beam is essentially dependent on the jet/beam guidance or the movement of a jet/beam nozzle relative to the component to be stripped of its layer(s) and dependent on the jet/beam cross-section when the jet/beam strikes the plating to be removed. As opposed to masking, there is therefore the advantage that the exposed surface is not predetermined by a tape geometry. For example, the exposed contact area in a plan view can have an essentially rectangular or at least in sections a curved basic shape.

Through the high flexibility of the method according to the subject matter of the invention, the surface of the contact area to be exposed on a connection part can be easily increased or reduced in a production plant by adapting the process parameters of the beaming source and/or the jet/beam guidance. Changing such a production plant over from a first connection part geometry to be processed to a second connection part geometry to be processed is also simplified.

According to one embodiment of the method according to the subject matter of the invention, at least one joint formed between two conductor components of the electrical conductor is electroplated. It was identified that a joint between two conductor components, which are preferably made from different metal materials, e.g. one component consisting of an aluminium material and one component consisting of a copper material, particularly has to be protected, in order to prevent contact corrosion by ambient moisture penetrating the joint. On the other hand, for contacting with a conductor consisting of the material of the contact point it must be freed from the plating.

The electroplating on the electrical conductor, particularly in the contact area, is removed at a distance from the joint, so that the joint is still electroplated after the contact area has been exposed. The joint is part of a connection area formed on the unplated electrical conductor between the conductor components, wherein the joint runs along the surface of the unplated electrical conductor facing the environment. Since the exposed contact area is arranged on the electrical conductor at a distance from the joint, the joint is protected against environmental influences, such as corrosion. In this way, an electrically conducting connection between the conductor components can be permanently guaranteed.

According to a further embodiment of the method according to the subject matter, the beaming source is a laser beam source. The electroplating can be removed in a targeted manner by means of the laser beam emitted by the beaming source. The plating is vaporised by short laser pulses (e.g. at a frequency of greater than 30 kHz and in particular less than 100 kHz) of high intensity (e.g. a power output of more than 20 W and in particular less than 100 W). By means of the treatment with the laser beam, the intended shape of the contact area to be exposed can be particularly precisely carved out of the plating. The process variables of the beaming treatment can be adapted to the nature of the plating to be removed, such as its composition or layer thickness, in such a way that the least possible input of heat into the electrical conductor occurs. Hence, the mechanical and electrical properties of the electrical conductor, particularly in its border zone facing the layer removal, essentially remain unaffected by the layer removal.

In the case where the electrical conductor is formed from at least two joined conductor components, the layer removal by means of a beaming source, particularly by means of a laser beam source, provides the advantage that the layer removal can take place close to a joint formed between the conductor components. For example, a contact area can be formed on the connection part at a distance of less than 2 mm, preferably less than 1 mm, more preferably less than 0.5 mm, from the joint. Therefore, more precise layer removal can be effected in close proximity to a joint formed between two conductor components when carrying out the method according to the subject matter of the invention using a beaming source, in particular a laser beam source, without exposing the joint covered by the plating to the environment. By means of precise layer removal, the width of a conductor component can be used in an optimum way for forming the contact area. The width of the contact area measured transverse to the longitudinal extension of the electrical conductor can be at least 80%, preferably at least 90%, more preferably at least 95%, of the width of the respective conductor component measured transverse to the longitudinal extension of the electrical conductor.

According to further embodiments of the method according to the subject matter of the invention, basically any type of beaming source which is suitable for removing the electroplating can be used as the beaming source. Thus, the contact surface can be exposed, for example, by means of a plasma jet source, by compressed-air beaming with a solid beaming agent, water-jet beaming, dry-ice beaming or CO₂-snow beaming.

According to a further embodiment of the method, the electroplating in the contact area is removed essentially free of residue. Here, “essentially free of residue” means that in the contact area, in particular on the surface of the contact area, at least 95%, preferably at least 98%, more preferably at least 99% of the electroplating has been removed. A particularly pure surface of the contact area can thereby be provided for joining a conductor or cable, for example by welding, in particular friction welding. In particular, the removal can be such that the plating in the contact area no longer constitutes any closed surface or covering of the contact area.

According to a further embodiment of the method according to the subject matter, the roughness of the surface of the exposed contact area is set by a surface treatment with the beaming source. The surface of the exposed contact area can in particular have an arithmetic mean roughness Ra of less than 15 μm, preferably less than 10 μm, more preferably less than 5 μm, after the surface treatment. The surface treatment can take place directly after the layer removal. For example, after essentially residue-free removal of the plating, the jet/beam can act on the surface of the exposed contact area for a specified period of time of, for example, at least 2 s, preferably at least 1 s, more preferably at least 0.5 s, in order to set the required roughness. The surface treatment can take place with beaming parameters which are the same for layer removal or which are specially adapted to the surface treatment. Thus, for example, roughness peaks in the region of the surface of the contact area can be smoothened by means of laser irradiation by local fusion and re-solidification.

According to a further embodiment, the method according to the subject matter is characterised by the fact that when providing the electrical conductor a first conductor component and a second conductor component of the electrical conductor are firmly bonded together. Such a firmly bonded connection can, for example, be effected by welding or cladding, in particular roll cladding. The firmly bonded connection guarantees a permanent electrically conducting connection between the conductor components. According to a further refinement of this embodiment, the first and/or the second conductor components can in particular be formed as flat conductors, as are used, for example, in automotive engineering in passenger cars and heavy-goods vehicles. In particular, according to the subject matter of the invention, the conductor can be used as a cable shoe, as a power conductor, as a battery lead or suchlike in a motor vehicle.

According to a further embodiment of the method according to the subject matter, the electrical conductor comprises a copper and/or an aluminium material. The electrical conductor can, for example, be produced from an aluminium flat conductor, which is formed from aluminium or an aluminium alloy, and from a copper flat conductor, which is formed from copper or a copper alloy. The aluminium conductor and the copper conductor can each be provided separately from one another and firmly bonded by roll cladding in a continuously running process. The conductor component to be applied can be of narrower width than the conductor component which forms the base. The electrical conductor produced in this way can be electroplated directly after joining the two conductor components without any further intermediate steps. The layer to be electro-deposited is therefore applied to the whole surface of the electrical conductor facing the environment, wherein each of the conductor components can be directly and completely covered by the layer without any intermediate elements. In this way, a homogenous layer application with an essentially constant layer thickness can be guaranteed.

According to a further embodiment of the method according to the subject matter, the electrical conductor is provided as a strip, wherein the strip is at least partly split up into strip sections, in particular is blanked, before or after plating takes place. Such a strip can be fed as a continuous material to a continuous production process, so that provision, plating and (partial) layer removal can be efficiently carried out directly one after another in a production plant. Depending on the chosen plating method, the strip is at least partly split up into strip sections before or after the plating, in order to produce separate electrical connection parts from the strip material in a simple way. The electroplating can according to the subject matter take place by means of strip plating or barrel plating. The particular suitable method can be selected depending on the quantity and the requirements of the end product.

In strip plating, the material to be plated is guided through an electrolytic bath as a continuous strip. In this way, a high material throughput can be generated and the plated continuous material easily passed on or continuously fed to the downstream processing stations of a production plant. The electrical connection parts can be separated from the strip as strip sections after the plating has taken place. Depending on the application conditions of the electrical connection part in the completely assembled state, it can be disadvantageous if a connection part split off in this way from a plated continuous strip is not plated in the area of its separation or cut face. This effect can be at least reduced if the strip is already partly split up before the plating takes place, in which the individual segments remain joined along a longitudinal side of the partly split-up strip via an unseparated band or bridge of the strip. In this way, the separation faces of the connection elements to be split off from the strip can also be at least partly plated.

In this respect, barrel plating has the advantage that separate strip sections already split off from a strip can be plated, so that the surface of these strip sections or conductor segments, from which the electrical connection elements are produced in the further course of the process, is fully plated. The separation faces of the strip sections resulting from the separation from the strip are also completely covered with the plating. Such barrel plating is also cheaper to operate compared to the previously described strip plating. In addition to protection against chemical environmental influences, which can lead to corrosion, the plating also serves to protect the electrical conductor against mechanical stresses, for example when transporting individual, plated strip sections to a beaming plant, in which the beaming source is arranged.

According to a further embodiment of the method according to the subject matter, the electrical conductor is coated with at least one electrically insulating material after the electroplating and before the contact area is exposed. The occurrence of leakage currents in the completed state of the connection part, for example in a motor vehicle, is counteracted by such an essentially non-conducting layer. When exposing the contact area, the electrically insulating layer can be locally removed together with the electroplating by means of the beaming source.

According to a further aspect, the subject matter relates to an electrical connection part, in particular produced according to a method carried out in the above described way according to the subject matter of the invention.

According to the subject matter, the electrical connection part can be formed from a first conductor component and a second conductor component, wherein the conductor components are firmly bonded together. The first and/or the second conductor components can in particular be formed as flat conductors. Thus, the electrical conductor can, for example, be formed from a conductor component consisting of an aluminium material and from a conductor component consisting of a copper material. The conductor components can be firmly bonded together by roll cladding.

According to a further embodiment of the connection part according to the subject matter, at least one joint formed between two conductor components of the electrical conductor is electroplated. An exposed contact area can be arranged at a distance from the electroplated joint. A contact area can serve to directly join another conductor to the exposed conductor component. The joint formed between the conductor components can be protected against environmental influences by the plating.

The contact area can be formed on the connection part in particular at a distance of less than 2 mm, preferably less than 1 mm, more preferably less than 0.5 mm, from the joint. Particularly precise beaming processes, such as the laser beam process or plasma jet process, enable layer removal to take place in close proximity to the joint without damaging the plating of the joint and exposing the joint. The width of the contact area measured transverse to the longitudinal extension of the electrical conductor can in particular be at least 80%, preferably at least 90%, more preferably at least 95% of the width of the respective conductor component measured transverse to the longitudinal extension of the electrical conductor.

The first conductor component can be arranged in a recess of the second conductor component provided for receiving the first conductor component, wherein the recess in particular is a groove. The conductor components can be formed as flat conductors, so that overall a rectangular cross-section of the electrical conductor results. In this case, the contact area can run closely adjacent to a joint formed between the conductor components, which, in this case, is defined by the respective side wall of the groove. In a plan view of the connection element, the contact area can be an area extended between two joints and having an essentially rectangular surface area.

According to a further embodiment of the connection part according to the subject matter, the surface of the contact area exposed using the beaming source can have an arithmetic mean roughness Ra of less than 15 μm, preferably less than 10 μm, more preferably less than 5 μm. In particular, the surface of the contact area can be optimised in terms of the joining technique, such as friction welding, chosen to join a conductor in the contact area.

According to a further embodiment of the subject matter, the electroplating in the contact area of the connection element according to the subject matter of the invention is removed essentially free of residue. As previously described with regard to the method, here the term “essentially free of residue” means that in the contact area, in particular on the surface of the contact area, at least 95%, preferably at least 98%, more preferably at least 99% of the electroplating has been removed. A particularly pure surface of the contact area can thereby be provided for joining a conductor or cable, for example by welding, in particular friction welding.

The subject matter is described in more detail below with the aid of the figures showing exemplary embodiments.

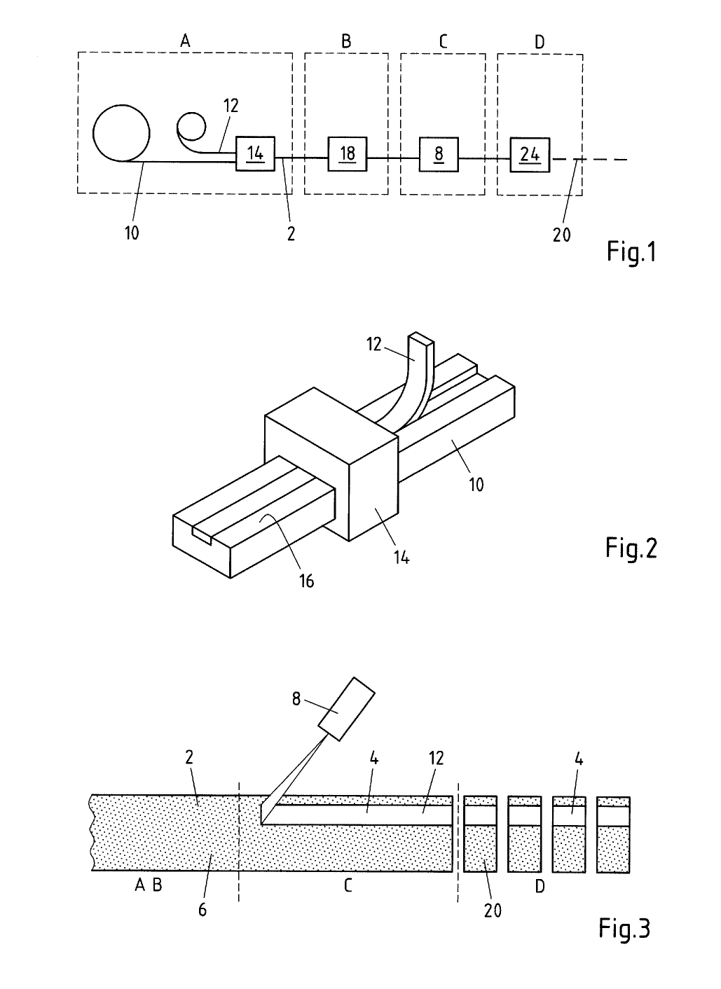

FIG. 1 shows a schematic design of a production method;

FIG. 2 shows a schematic illustration of a first method step A;

FIG. 3 shows another schematic illustration of the method according to FIG. 1;

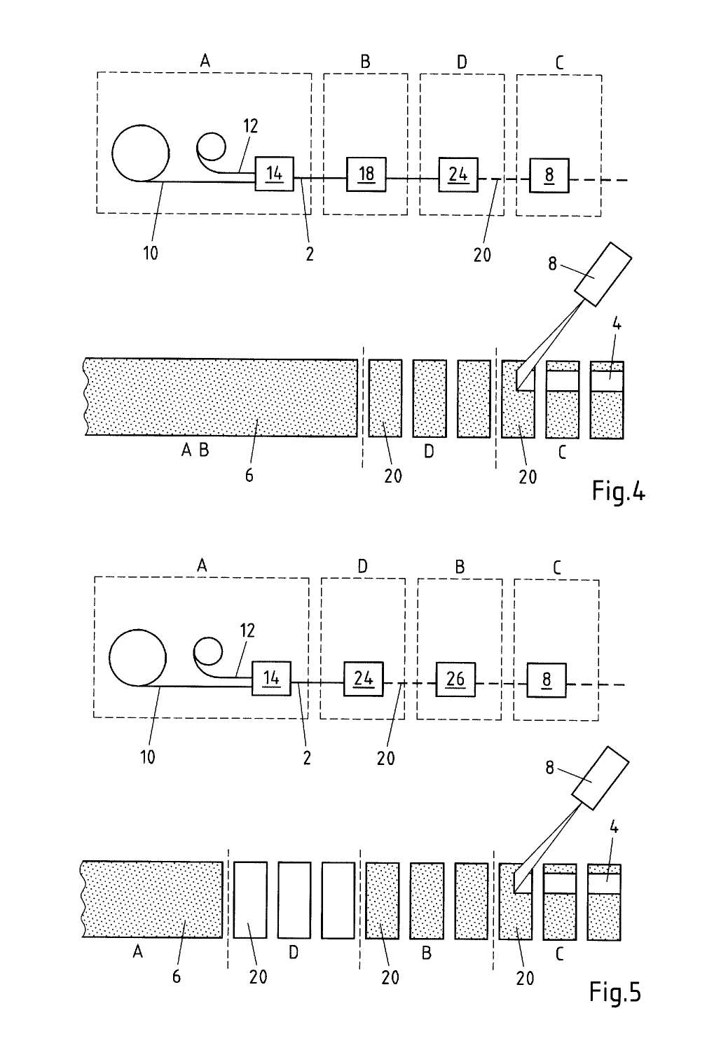

FIG. 4 shows a second schematic design of a production method;

FIG. 5 shows a third schematic design of a production method;

FIG. 6 shows a plan view of an electrical connection part;

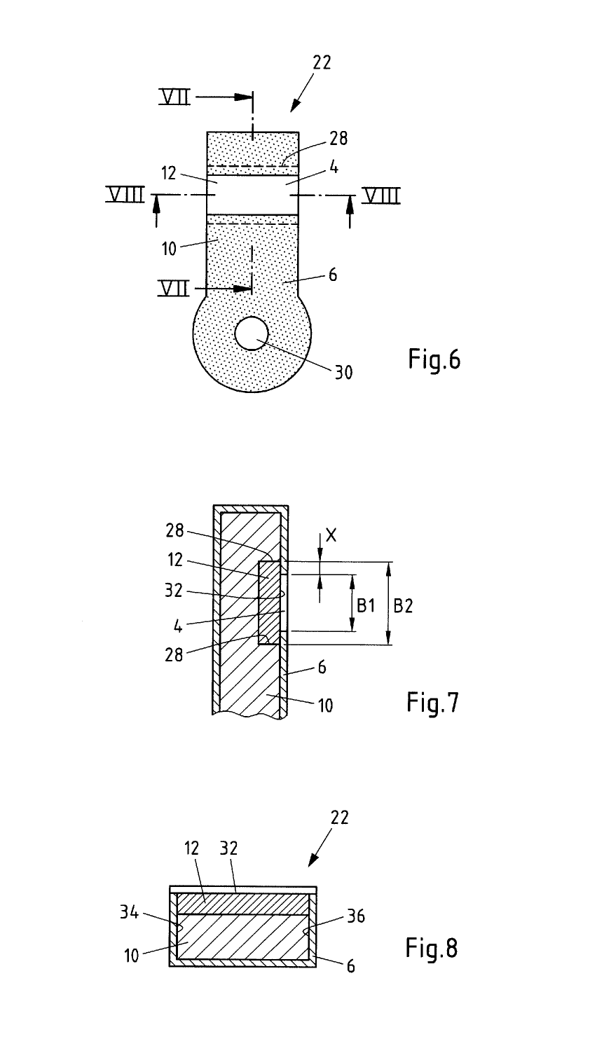

FIG. 7 shows a sectional view of the electrical connection part from FIG. 6;

FIG. 8 shows another sectional view of the electrical connection part from FIG. 6.

A schematic design of a method according to the subject matter for producing an electrical connection part is illustrated in FIG. 1. In a first method step A, an electrical conductor 2 is provided. In a second method step B, the electrical conductor 2 is electroplated. In a third method step C, a contact area 4 of the electrical conductor 2 is exposed. In the process, the electroplating 6 is removed using a beaming source 8. The electrical conductor 2 is produced from a first conductor component 10 and a second conductor component 12. The first conductor component 10 is a flat conductor consisting of a copper material, while the second conductor component 12 is a flat conductor consisting of an aluminium material. However, it is also possible for this combination to be formed exactly the other way round. The first conductor component 10 and the second conductor component 12 can each be provided in a coil and continuously conveyed to the device 14. The first conductor component 10 and the second conductor component 12 can be firmly bonded together in the device 14 by roll cladding.

A schematic illustration of the roll cladding taking place in the first method step A is shown in FIG. 2. The conductor component 10 and the conductor component 12 are conveyed to the device 14 such that the conductor component 12 is received in a groove provided on the conductor component 10. The conductor component 10 and the conductor component 12 are joined by a roller (not illustrated) provided in the device 14 in such a way that they are flush with the adjacent areas in the area of a surface 16. However, with roll cladding the groove can also be omitted.

In the second method step B, the electrical conductor 2 formed from the conductor components 10 and 12 is guided through the apparatus 18 in which the electrical conductor 2 is electroplated. The apparatus 18 is a strip plating apparatus. The electrical conductor 2 is, in a continuous process, guided through one or more electrolytic baths and is provided with a plating 6 which is, for example, a few micrometres thick. In method step B, one or more electroplated layers can be deposited on the electrical conductor. A respective layer can, for example, comprise nickel and/or tin. After the electroplating, in method step B another electrically insulating layer can be applied. This layer serves to prevent leakage currents in the completed state of the connection part.

In the third method step C, the contact area 4 of the electrical conductor 2 is exposed, wherein the electroplating 6 is removed by means of the beaming source 8. In the example illustrated here, the beaming source 8 is a laser beam source. As can be gathered from the schematic illustration according to FIG. 3, the electrical conductor 2 provided with the electroplating 6 and the insulating layer is guided past the beaming source 8 in a continuous process. In the process, the electroplating 6 essentially completely vaporises in the contact area 4, so that the electroplating 6 is removed essentially free of residue. In this way, the conductor component 12, i.e. the aluminium conductor, is exposed, so that in the contact area 4 another conductor (not illustrated) can be directly joined to the aluminium conductor. In particular, in the area of the contact point, a homogeneous connection with another conductor which consists of the material of the contact point can be produced. Another conductor consisting of another material can be firmly bonded to the plating.

In a fourth method step D, individual sections 20 are separated or split off from the continuous material formed from the two coils of the conductor components 10 and 12, from which individual sections 20 separate electrical connection parts 22 are produced in the further course of the process. The separation process can be effected by means of a blanking device 24, in which, in addition to the separation, shaped elements can also be formed on a respective connection part 22.

A second schematic design of a production method according to the subject matter of the invention is illustrated in FIG. 4. The design shown in this exemplary embodiment differs from the method described with regard to FIGS. 1 to 3, in that the sections 20 have already been split off directly after the electroplating. The separation process D, previously executed as the fourth method step, now takes place before exposure of the contact area 4 according to method step C. The individual sections 20 can, as illustrated here, already be completely separated from one another or alternatively remain joined together along a longitudinal side via a common band or a common transport strip, in order to make transporting of the sections 20 in the further course of the process easier.

FIG. 5 shows a third schematic design of a production method according to the subject matter of the invention, in which in this case splitting up of the continuous material formed from the conductor components 10 and 12 into sections 20 already takes place before the plating. In this case, the unplated sections 20 are conveyed to a barrel plating apparatus 26 in method step B. Compared to the previously described methods, this approach has the advantage that the separation or cut edges, along which the sections 20 are separated from one another, are also plated.

Preferably, in the case of the above described methods, the contact area 4 is exposed directly before joining a further conductor, so that the formation of a non-conducting aluminium oxide layer in the contact area 4 can be prevented.

An electrical connection part 22, which was produced according to one of the above described methods, is described below with reference to FIGS. 6 to 8.

FIG. 6 shows a plan view of the electrical connection part 22 which has a conductor component 10 and a conductor component 12. The electrical connection part 22 is provided with a metallic plating 6. The plating 6 covers two joints 28 formed between the conductor components 10, 12. It is evident that the respective joint 28 is arranged at a distance X from the exposed contact area 4, so that the joint 28 is completely covered by the plating 6. The distance X is less than 1 mm in the example illustrated here. The width B1 of the contact area 4 is approximately 90% of the width B2 of the aluminium conductor 12. In addition, a through-hole 30, for receiving a screw or a bolt for example, is formed on the electrical connection part 22.

A sectional view of the electrical connection part 22 along the line VII-VII from FIG. 6 is illustrated in FIG. 7. As can be clearly identified here, the joint 28 is protected from the environment by the plating 6. Layer removal on the surface 32 of the contact area was firstly carried out using the laser beam source 8 and directly after that the surface 32 of the contact area was smooth finished. An arithmetic mean roughness of approximately 10 μm was set on the surface 32 by means of the beaming source 8.

FIG. 8 shows another sectional view of the electrical connection part from FIG. 6 along the line VIII. While the previously described specifications equally apply for both the first and the second described production methods for producing an electrical connection part 2, the specifications with regard to the plating 6 according to FIG. 8 are limited to the third production method which makes use of barrel plating 26. Thus, it can be identified here that the plating 6 also covers the junction between the conductor component 10 and the conductor component 12 along the lateral separation faces 34, 36 and in this way protects against environmental influences.

1. Method for producing an electrical connection part comprising:
providing an electrical conductor;
electroplating the electrical conductor;
exposing a contact area of the electrical conductor by removing the electroplating in the contact area using a beaming source.

2. Method according to claim 1, wherein
at least one joint formed between two conductor components of the electrical conductor is electroplated,
and in that the electroplating on the electrical conductor is removed at a distance (X) from the joint, so that the joint is still electroplated after the contact area has been exposed.

3. Method according to claim 1 wherein the beaming source is a laser beam source.

4. Method according to claim 2, wherein
the contact area on the connection part is formed at a distance (X) of less than 2 mm from the joint,
and/or
in that the width (B1) of the contact area measured transverse to the longitudinal extension of the electrical conductor is at least 80% of the width (B2) of the respective conductor component measured transverse to the longitudinal extension of the electrical conductor.

5. Method according to claim 1, wherein the electroplating in the contact area is removed essentially free of residue.

6. Method according to claim 1, wherein
the roughness of the surface of the exposed contact area is set by a surface treatment with the beaming source such that
the surface of the exposed contact area in particular has an arithmetic mean roughness Ra of less than 15 μm.

7. Method according to claim 1, wherein
when providing the electrical conductor a first conductor component and a second conductor component of the electrical conductor are firmly bonded together,
wherein the first and/or the second conductor components are formed as flat conductors.

8. Method according to claim 1, wherein the electrical conductor comprises a copper and/or an aluminium material.

9. Method according to claim 1, wherein the electrical conductor is provided as a strip,
wherein the strip is at least partly split up into strip sections, in particular is blanked, before or after plating takes place.

10. Method according to claim 1, wherein the electroplating takes place by means of strip plating or barrel plating.

11. Method according to claim 1, wherein the electrical conductor is coated with at least one electrically insulating material after the electroplating and before the contact area is exposed.

12. Electrical connection part produced according to a method according to claim 1.

13. Electrical connection part according to claim 12, wherein
at least one joint formed between two conductor components of the electrical conductor is electroplated,
wherein the exposed contact area is arranged at a distance (X) from the electroplated joint,
wherein the contact area on the connection part is in particular formed at a distance (X) of less than 2 mm from the joint
and/or
in that the width (B1) of the contact area measured transverse to the longitudinal extension of the electrical conductor is at least 80% of the width of the respective conductor component measured transverse to the longitudinal extension of the electrical conductor.

14. Electrical connection part according to claim 13, wherein the surface of the contact area exposed by the beaming source has an arithmetic mean roughness Ra of less than 15 μm.

15. Electrical connection part according to claim 12, wherein the electroplating in the contact area is removed essentially free of residue.

16. Electrical connection part according to claim 12, wherein
the electrical conductor has a first conductor component and a second conductor component and/or
in that the conductor components of the electrical conductor are firmly bonded together and are roll-clad.

17. Electrical connection part according to claim 12, wherein the electrical conductor has a first conductor component and a second conductor component and wherein the first and/or the second conductor components are formed as flat conductors.

18. Electrical connection part according to claim 12, wherein the electrical conductor has a first conductor component and a second conductor component and in that the first and/or the second conductor components are formed from a copper or an aluminium material, wherein the conductor components are formed from different metal materials.
